(19) United States
(12) Patent Application Publication
(10) Pub. No.: US 2023/0409989 A1
(43) Pub. Date: Dec. 21, 2023

(54) METHOD FOR AGGREGATING AND PRESENTING AGGREGATED ASSET MODELS

(71) Applicant: Schlumberger Technology Corporation, Sugar Land, TX (US)

(72) Inventors: Daiye ZHENG, Kuala Lumpur (MY); Jason DRESSEL, Calgary (CA); Rajes MUTTHUSAMY, Kuala Lumpur (MY); Niranjan Madhukar KARVEKAR, Pune (IN); Yulia ANTONEVICH, Abingdon (GB); Mohd Faizal UZAIRI, Selangor (MY); Shiv Nihal VIDYALA, Pune (IN); Anina MENDEZ, London (GB)

(21) Appl. No.: 18/251,141

(22) PCT Filed: Oct. 27, 2021
(86) PCT No.: PCT/US2021/056751

§ 371 Date: Apr. 28, 2023

Related U.S. Application Data
(60) Provisional application No. 63/198,622, filed on Oct. 30, 2020.

(51) Int. Cl. G06Q 10/04; G06Q 50/06

(52) U.S. Cl. CPC G06Q 10/04; G06Q 50/06

(57) ABSTRACT

Methods, computing systems, and computer-readable media for aggregating a plurality of individual asset models of which the method includes storing information representing the plurality of individual asset models, generating a plurality of grouped asset models by aggregating the plurality of individual asset models based on a common property shared by the plurality of individual asset models, constructing a tree comprising a hierarchy of a plurality of levels and sub-levels associated with the plurality of grouped asset models and the plurality of individual asset models, and displaying the tree in a user interface.

### CROSS REFERENCE TO RELATED APPLICATIONS

The present application claims priority benefit of U.S. Provisional Application No. 63/198622, filed Oct. 30, 2020, the entirety of which is incorporated by reference herein and should be considered part of this specification.

### BACKGROUND

In the oil and gas domain, an asset may include any type of property, good, land, etc. that may have value for oil and gas exploration and recovery. For example, an asset may include a field (e.g., developed or undeveloped field) in which hydrocarbons may reside for oil and gas recovery.

Assets may be located in various locations, countries, municipals, etc., across the globe in which different types of costs and/or contract terms may be associated with different locations. For example, different locations may enforce different laws, policies, taxes, etc. that may affect the cost and/or expense of maintaining, developing, exploring, and/or recovering oil and gas from an asset.

### SUMMARY

Embodiments of the disclosure may provide a method for aggregating a plurality of individual asset models. The method includes storing information representing the plurality of individual asset models, generating a plurality of grouped asset models by aggregating the plurality of individual asset models based on a common property shared by the plurality of individual asset models, constructing a tree comprising a hierarchy of a plurality of levels and sub-levels associated with the plurality of grouped asset models and the plurality of individual asset models, and displaying the tree in a user interface.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example user interface presenting a hierarchal tree of different asset models at different levels.

FIG. 3 illustrates an example flowchart of a process for generating, aggregating, and presenting asset models in a hierarchal format.

FIG. 4 illustrates a schematic view of a computing system, according to an embodiment.

### DETAILED DESCRIPTION

Aspects of the present disclosure may generate and store asset models (e.g., forecasted profit models, revenue models, expense models, etc.) for multiple assets (e.g., oil/gas related assets) associated with an organization (e.g., an oil producer, explorer, etc.). As described herein, the asset models may factor in different types of costs associated with different regions in which different assets are located. For example, the asset models may factor in different laws, policies, taxes, contract terms, etc. associated with different assets. In some embodiments, aspects of the present disclosure may aggregate and present asset models by groups (e.g., region, country, area, etc.). In this way, asset models from different regions may be “rolled-up” such that forecasts from multiple assets may be modeled rather than modeling forecasts from only a single model. Further, aspects of the present disclosure may visually present individual and grouped/aggregated asset models in a hierarchical manner (e.g., a tree) such that the grouping of individual asset models may be customized.

In some embodiments, aspects of the present disclosure may generate aggregated asset models at different levels based on individual asset models. For example, aspects of the present disclosure may generate individual level asset models, county level asset models, municipal level asset models, state/province level asset models, country level asset models, continent level asset models, and/or world level asset models. As described herein, a county level asset model may include an aggregation of all individual asset models within a county, a municipal level asset model may include an aggregation of all individual asset models within a municipality, a state/province level asset model may include an aggregation of all individual asset models within a state/province, and so on and so forth until the highest level model has been reached (e.g., a continent level asset model or a world level asset model). Also, as described herein, a user may customize or select grouping parameters for grouping the individual asset models in some other fashion. For example, the user may select to group the asset models based on common features, or group two country's asset models together, etc. Additionally, or alternatively, the user may select to group models by different types (e.g., project asset models, contract asset models, legal asset models, etc.).

In some embodiments, the aggregated asset models may be presented graphically in a user interface as a hierarchy (e.g., tree) on a geographic map (e.g., by continent) and broken down to smaller levels (e.g., from the world level or continent level model down to the individual level model). In some embodiments, a user may browse through the hierarchy and provide user inputs for “drilling down” to lower level models. Further, the user may provide user inputs to customize the grouping of asset models. In some embodiments, aspects of the present disclosure may receive the grouping selections and may aggregate individual asset models in the selected group for display within the user interface.

As described herein, aggregating individual asset models by groups and presenting the aggregated models to the user may assist the user (and/or other users in an organization associated with the assets) to more accurately analyze projected forecast models (e.g., models related to profit, cost, revenue, etc.) by group (e.g., by region, country, etc.). Further, aggregated models may be compared to identify reasons for discrepancies between the models. As one illustrative example aspects of the present disclosure may assist a user to identify that one country's aggregate asset model forecasts significantly higher profits than another country's aggregate asset model. This type of identification may serve as a basis for beginning an investigation, root cause analysis, workflow, etc., to identify causes for discrepancies in forecasts between different asset models of different countries.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

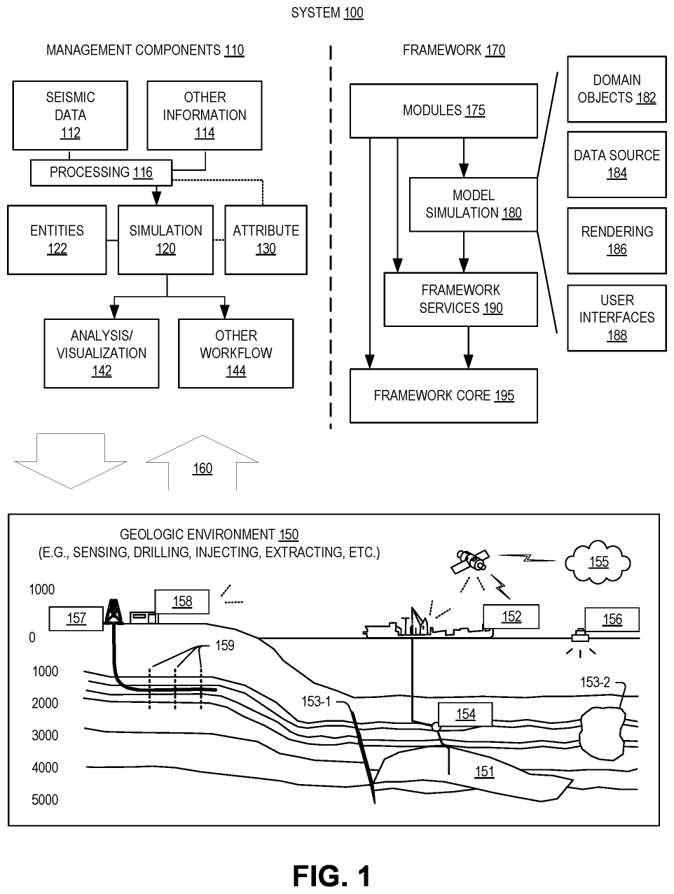

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

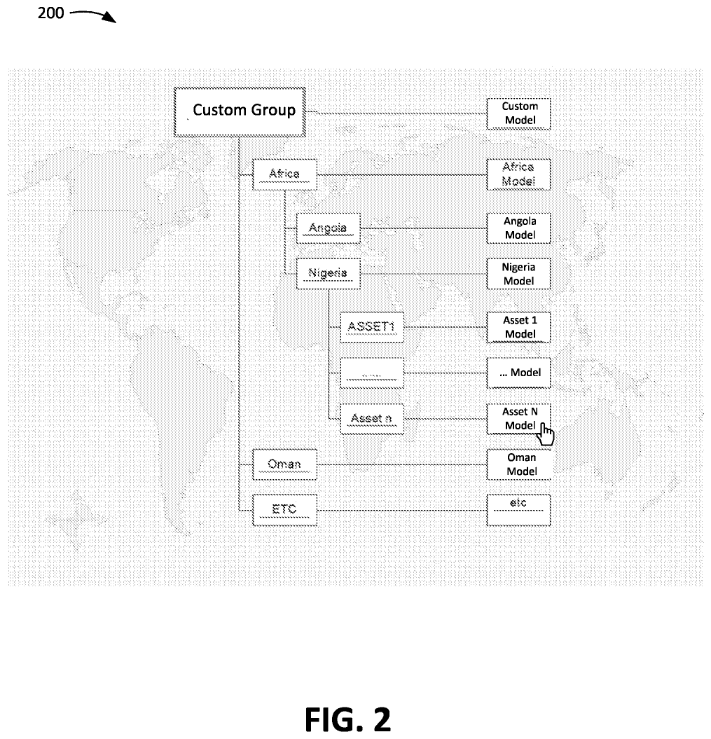

FIG. 2 illustrates an example user interface presenting a hierarchal tree of different asset models at different levels (e.g., in which a top level is a custom group having an aggregation of asset models from different user-selected continents and countries). As shown in the interface 200 of FIG. 2, different asset models at different levels and sub-levels may be presented and selected down to the individual asset level model. In the example shown in FIG. 2, the group “Africa” may be a sub-level (e.g., one level down) of the “custom group” level in which the “Africa” group includes an aggregation of asset models for assets located in countries in the Africa continent. As shown in the interface 200, lower level asset models may be accessed be selecting a parent model. For example, Asset model N may be selected by selecting “Custom Group” which may expand the tree to show the “Africa” group. In some embodiments, selecting the Asset model N may present details regarding this individual asset. Selecting the “Africa” group may expand this group and present different countries in Africa (e.g., Angola, Nigeria, etc.). Selecting the “Nigeria” group may expand to list all the assets located in Nigeria. Selecting “Asset N” may present a link to the individual asset model for “Asset N.” In some embodiments, higher level models may be presented (e.g., by selecting the higher level model). For example, the “Custom Model” may be selected to present an aggregated model including an aggregation of all individual asset models and/or country/grouped models under the “Custom Model” group.

In some embodiments, other hierarchy levels may be presented. An example table of different hierarchy levels, inputs to producing models for the hierarchy levels, and attributes modeled are presented below in table 1.

TABLE 1
Example Hierarchy Levels and Modeled Attributes

| Example | | |
|---|---|---|
| Hierarchy | | Example Attributes |
| Level | Example Input | Modeled |
| Project | Project data from data source | Project sales revenue, total |
| | (production, cost) | Capex and total Opex. |
| Asset (Field) | Aggregated from all projects | Capital depreciation, |
| | | Book amortisation |
| Contract/ | Aggregated input from all | Contract term terms - e.g. |
| Concession | assets under the same | Cost recovery, Profit |
| | contract/concession | Sharing, Royalty, |
| | | Petroleum tax etc. |
| | | Economic indicators |
| Legal (Tax) | Aggregated from all contracts | Corporate Income Tax, |
| entity | in a legal entity | Deferred Tax, Financing, |
| | | Dividend etc. Economic & |
| | | financial indicators |
| Country | Aggregated from all legal | Recalculate Corporate |
| | entities within a country | Income tax; Economic & |
| | | financial indicators |
| Regions | Aggregated from all countries | Economic & financial |
| | within a region | indicators |
| Group | Aggregated from all regions | Consolidation. Inter-group |
| | | elimination. Economic & |
| | | financial indicators |

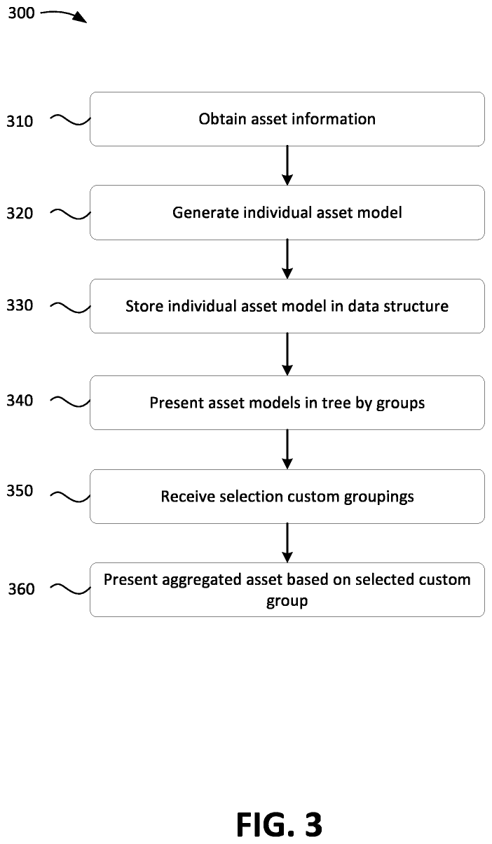

FIG. 3 illustrates an example flowchart of a process for generating, aggregating, and presenting asset models in a hierarchal format. The blocks of FIG. 3 may be implemented by a computing system, such as a hierarchal model aggregation system. As noted herein, the flowchart illustrates the architecture, functionality, and operation of possible implementations of systems, methods, and computer program products according to various embodiments of the present disclosure.

As shown in FIG. 3, The process 300 may include obtaining asset information (block 310). For example, the hierarchal model aggregation system may obtain asset information from a database or data source that stores the asset information, including, for example, type of asset, the location of the asset, and/or other attributes of the asset.

The process 300 also may include generating an individual asset model (block 320). For example, the hierarchal model aggregation system may generate and individual asset model for the asset based on the asset information. As described herein, the individual asset model may include a projection of profits, revenues, expenses, oil/gas recovery/production, etc. Additionally, or alternatively, the individual asset model may model any other type of attribute associated with the asset.

The process 300 further may include storing the individual asset model in a data structure (block 330). For example, the hierarchal model aggregation system may store the individual asset model in a data structure or database in which the data structure identifies one or more properties of the asset (e.g., asset type, location, rate of profit growth/decline, etc.).

The process 300 also may include presenting asset models in a tree by groups (block 340). For example, the hierarchal model aggregation system may present asset models (e.g., stored in the data structure or database) in a tree (e.g., similar to the example shown in FIG. 2). In some embodiments, the hierarchal model aggregation system may present assets in a default view in which the assets are grouped in a default manner with default asset model levels and sub-levels (e.g., by continent, country, state/province, down to individual assets). In some embodiments, the hierarchal model aggregation system may construct the tree by linking and grouping the individual asset models together by a common property (e.g., by location, attribute type, and/or other common property shared by the individual asset models). As shown in FIG. 2, the individual asset models may be presented by levels and sub-levels in which higher level asset models include an aggregation of lower level asset models. Thus, the hierarchal model aggregation system may generate higher level asset models based on the individual asset models included in the higher level asset models.

The process 300 further may include receiving a selection of custom groupings (block 350). For example, the hierarchal model aggregation system may receive a selection of custom groupings via the user interface (e.g., the user interface 200 of FIG. 2) in which a user may interactively select asset models to group. In some embodiments, the user may select to “roll-up” (or collapse) multiple lower-level models into one higher-level model, or may select to “break down” or “drill down” (or expand) a higher-level model into lower-level models. Additionally, or alternatively, the user may select to group different models together to form a custom group.

The process 300 also may include presenting an aggregated asset based on the selected custom group (block 360). For example, the hierarchal model aggregation system may aggregate individual asset models based on the custom grouping selections received at block 350. As an example, the hierarchal model aggregation system may aggregate lower-level asset models into a higher-level model (e.g., a country level model including individual asset models in a selected country). In some embodiments, steps 350 and 360 may be repeated as the user interacts with the user interface and selects to expand and/or collapse higher-level and lower-level models.

Aspects of the present disclosure may allow long-term forecasting of non-E&P midstream and downstream projects. Aspects of the present disclosure may bring together E&P, midstream, downstream and other high capex projects. Aspects of the present disclosure may improve the complex modeling of E&P projects within ring fence, shared cost and other complex relationships that may integrate with the an organizations overall planning process.

Aspects of the present disclosure may apply to calculations for modeling at different levels in a hierarchy. Aspects of the present disclosure allow the standardization of complex integrated hierarchy-based economic and financial modeling for business planning, capital allocation and decision-making across the organization. Aspects of the present disclosure may enforce complex fiscal situations (e.g. ring fences, cost allocation, incremental hierarchy-based calculations).

Aspects of the present disclosure may improve reliability and confidence in the input data and the results of underlying analysis and may shorten the time of a workflow, allowing for more frequent (possibly continuous) analysis. The capability to model downstream and complex oil and gas projects may be extend to further vertically integrate into different organizations, such as oil and gas companies. Aspects of the present disclosure may also be applied to non-traditional E&P projects (e.g. marketing, distribution and carbon sequestration, etc.). Aspects of the present disclosure may cover the full spectrum of complex integrated modeling for planning and offer a fully integrated solution. Users may use the technique described herein to define and enforce their corporate planning workflows and processes.

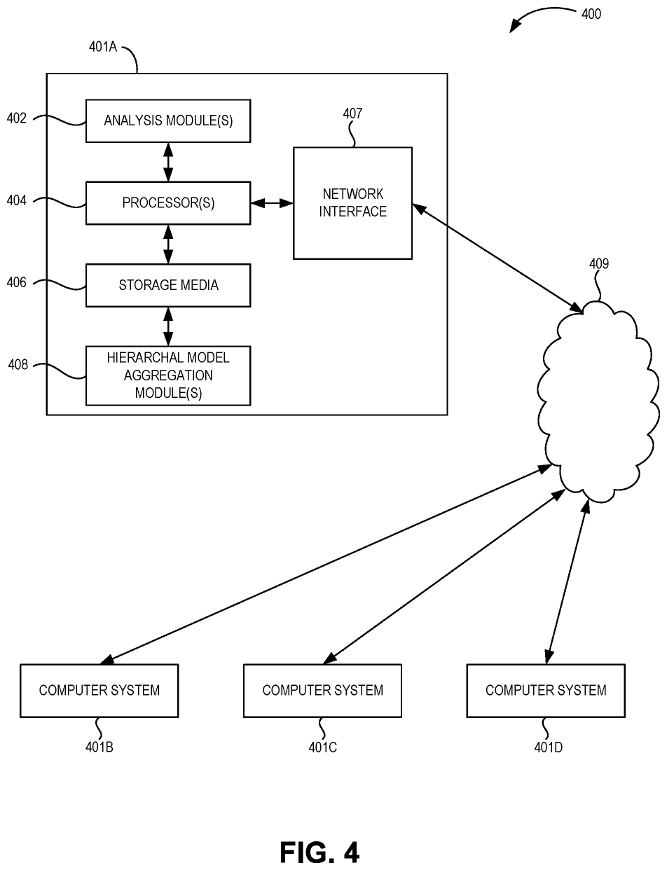

In some embodiments, the methods of the present disclosure may be executed by a computing system. FIG. 4 illustrates an example of such a computing system 400, in accordance with some embodiments. The computing system 400 may include a computer or computer system 401A, which may be an individual computer system 401A or an arrangement of distributed computer systems. The computer system 401A includes one or more analysis modules 402 that are configured to perform various tasks according to some embodiments, such as one or more methods disclosed herein. To perform these various tasks, the analysis module 602 executes independently, or in coordination with, one or more processors 404, which is (or are) connected to one or more storage media 406. The processor(s) 404 is (or are) also connected to a network interface 407 to allow the computer system 401A to communicate over a data network 409 with one or more additional computer systems and/or computing systems, such as 401B, 401C, and/or 401D (note that computer systems 401B, 401C and/or 401D may or may not share the same architecture as computer system 401A, and may be located in different physical locations, e.g., computer systems 401A and 401B may be located in a processing facility, while in communication with one or more computer systems such as 401C and/or 401D that are located in one or more data centers, and/or located in varying countries on different continents).

A processor may include a microprocessor, microcontroller, processor module or subsystem, programmable integrated circuit, programmable gate array, or another control or computing device.

The storage media 406 may be implemented as one or more computer-readable or machine-readable storage media. Note that while in the example embodiment of FIG. 4 storage media 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 400 contains one or more hierarchal model aggregation module(s) 408. In the example of computing system 400, computer system 401A includes the hierarchal model aggregation module 408. In some embodiments, a single hierarchal model aggregation module may be used to perform some aspects of one or more embodiments of the methods disclosed herein. In other embodiments, a plurality of hierarchal model aggregation modules may be used to perform some aspects of methods herein.

It should be appreciated that computing system 400 is merely one example of a computing system, and that computing system 400 may have more or fewer components than shown, may combine additional components not depicted in the example embodiment of FIG. 4, and/or computing system 400 may have a different configuration or arrangement of the components depicted in FIG. 4. The various components shown in FIG. 4 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 400, FIG. 4), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

1. A method for aggregating a plurality of individual asset models, comprising:
storing information representing the plurality of individual asset models;
generating a plurality of grouped asset models by aggregating the plurality of individual asset models based on a common property shared by the plurality of individual asset models;
constructing a tree comprising a hierarchy of a plurality of levels and sub-levels associated with the plurality of grouped asset models and the plurality of individual asset models; and
displaying the tree in a user interface.

2. The method of claim 1, further comprising:
receiving a selection for a custom group within the user interface;
determining a particular subset of the plurality of individual asset models in the custom group;
aggregating the particular subset of the plurality of individual asset models to form a custom group asset model; and
presenting the custom group asset model within the tree.

3. The method of claim 1, wherein an asset represented by the plurality of individual asset models comprises an oil/gas-related asset.

4. The method of claim 1, wherein the plurality of levels and sub-levels comprise different geographic regions or properties associated with the individual asset models.

5. The method of claim 1, wherein the plurality of individual asset models comprises at least one of:
a profit forecasting model;
a depreciation forecasting model;
a revenue forecasting model; or
an expense forecasting model.

6. The method of claim 1, wherein the plurality of individual asset models and the plurality of grouped asset models are grouped by at least one of:
region;
country;
continent;
legal entity;
contract identifier;
project; or
field.

7. The method of claim 1, wherein the plurality of individual asset model in the are generated based on expenses, contracts, or legal policies associated with geographic areas linked to the plurality of individual asset models.

8. A computing system, comprising:
one or more processors; and
a memory system comprising one or more non-transitory computer-readable media storing instructions that, when executed by at least one of the one or more processors, cause the computing system to:
store information representing a plurality of individual asset models;
generate a plurality of grouped asset models by aggregating the plurality of individual asset models based on a common property shared by the plurality of individual asset models;
construct a tree comprising a hierarchy of a plurality of levels and sub-levels associated with the plurality of grouped asset models and the plurality of individual asset models; and
display the tree in a user interface.

9. A non-transitory computer-readable medium storing instructions that, when executed by one or more processors of a computing system, cause the computing system to:
store information representing a plurality of individual asset models;
generate a plurality of grouped asset models by aggregating the plurality of individual asset models based on a common property shared by the plurality of individual asset models;
construct a tree comprising a hierarchy of a plurality of levels and sub-levels associated with the plurality of grouped asset models and the plurality of individual asset models; and
display the tree in a user interface.
